(19) United States
(12) Patent Application Publication
(10) Pub. No.: US 2012/0103160 A1
(43) Pub. Date: May 3, 2012

(54) CRUSH CUT BLADE ASSEMBLY

(75) Inventors: Bill Shea, Charlton, MA (US); Robert Keskula, Holden, MA (US)

(73) Assignee: Dienes Corporation USA, Spencer, MA (US)

(21) Appl. No.: 12/916,143

(22) Filed: Oct. 29, 2010

(51) Int. Cl. B26D 7/26; B23P 11/00

(52) U.S. Cl. 83/698.41; 29/428

(57) ABSTRACT

A crush cut blade assembly comprising an axle pin adapted to be mounted in a holder and provided with a first set of two separate vee tracks disposed on a radially outer periphery of the axle pin; a blade disposed radially outwardly of, and concentrically about, the axle pin and provided with a second set of two separate vee tracks disposed on a radially inner periphery of the blade, the vee tracks of the blade being respectively disposed across from the vee tracks of the axle pin such that the vee tracks of the first set of vee tracks are respectively aligned with the vee tracks of the second set of vee tracks; and bearing balls disposed between the axle pin and the blade in both of the aligned vee tracks of the axle pin and of the blade.

### BACKGROUND OF THE INVENTION

The present invention relates to a crush cut blade assembly, especially for use in crush or score cutting.

There are two primary elements involved in the process of crush or score cutting, namely the score or crush cut blade, and the anvil roll. Both of these components are round, and both rotate on parallel axes of rotation. The blade has a relatively sharp outer diameter that is pressed against the smooth anvil roll with a force that is substantial enough to crush or score the material that is being processed as it is being passed between the two components (see FIG. 1). The material of the blade and anvil are typically hardened steel, with a high pressure concentration at the point of cut. The life expectancy of the blade is affected by such conditions as material, finish, speed, pressure, alignment and the like. The blade of heretofore known assemblies is typically mounted on one, single row, radial ball bearing, which in turn is mounted on an axle pin that is held in a crush cut holder. The known assemblies require very close tolerances in order to minimize wobble and hence misalignment of the blade, which causes the blade to follow a spiral path along the face of the anvil roll. Furthermore, with the known assemblies with their single radial bearing, the high crush cut forces that are required result in a reduction in bearing life since the low bearing capacity of such assembly is unable to adequately resist the side loads that are transmitted to the blade tip by the crush cutting action. The very close tolerances, in particular the very slight clearance between the sides of the blade and the inner surfaces of the holder side plates, are necessary in order to support the blade during operation. However, such reduced clearance results in a great build-up of heat when the assembly is running at high speeds; this further contributes to early failure of the bearing.

It is therefore an object of the present application to provide a crush cut blade assembly that overcomes the aforementioned drawbacks.

### BRIEF DESCRIPTION OF THE DRAWINGS

This object, and other objects and advantages of the present invention, will appear more clearly from the following specification in conjunction with the accompanying schematic drawings, in which:

FIG. 1 shows a conventional crush cutter;

FIG. 2 illustrates the side wobble resulting from the insufficient blade support provided by a conventional crush cutter;

FIG. 3a shows an axle pin/blade assembly pursuant to the present application mounted in a holder;

FIG. 3b is a cross-sectional view through the holder and assembly of FIG. 3a taken along the line 3b-3b thereof;

FIG. 4 is an enlarged view of the encircled area A in FIG. 3b showing the race configurations of the axle pin and the blade;

FIG. 5 is an enlarged view showing the dual vee race concept of the axle pin/blade assembly;

FIG. 6 shows the axle pin in a side and an end view;

FIG. 7a is a side view of the knife or blade;

FIG. 7b is a cross-sectional view through the blade of FIG. 7a taken along the line 7b-7b thereof; and

FIG. 8 is an enlarged view of the dual vee, axle pin/blade assembly mounted in the fork support of the holder.

### SUMMARY OF THE INVENTION

The crush cut blade assembly of the present application comprises an axle pin adapted to be mounted in a holder, such as the fork support of the holder, wherein the axle pin is provided with a first set of two separate vee tracks disposed on a radially outer periphery of the axle pin; a blade disposed radially outwardly of, and concentrically about, the axle pin, wherein the blade is provided with a second set of two separate vee tracks disposed on a radially inner periphery of the blade, and wherein the vee tracks of the blade are respectively disposed across from the vee tracks of the axle pin such that the vee tracks of the first set of vee tracks are respectively aligned with the vee tracks of the second set of vee tracks; and bearing balls disposed between the axle pin and the blade in both of the aligned vee tracks of the axle pin and of the blade respectively. The vee tracks of the first and second sets of vee tracks are preferably respectively disposed on opposite sides of a radially extending, central plane of the crush cut blade assembly. In addition, the vee tracks of the first and second sets of vee tracks can be disposed symmetrically relative to the central plane.

With the crush cut blade assembly of the present application, the axle pin/blade combination has a greater ability to resist side loads due to the presence of the bearings in the dual vee tracks. This allows the blade to maintain alignment so that it can follow a straight path along the face of the anvil roll. In addition, the dual vee race concept of the axle pin/blade assembly of the present application does not require the close tolerances necessary with the heretofore known assemblies. In particular, the assembly of the present application allows for an increase in the clearance between the outer surfaces of the blade and the inner surfaces of the side plates of the holder. This increased clearance eliminates the prior art problems of a significant build-up of heat when the assembly runs at higher speeds, thus prolonging the life of the bearings.

Further specific features of the present application will be described in detail subsequently.

### DESCRIPTION OF SPECIFIC EMBODIMENTS

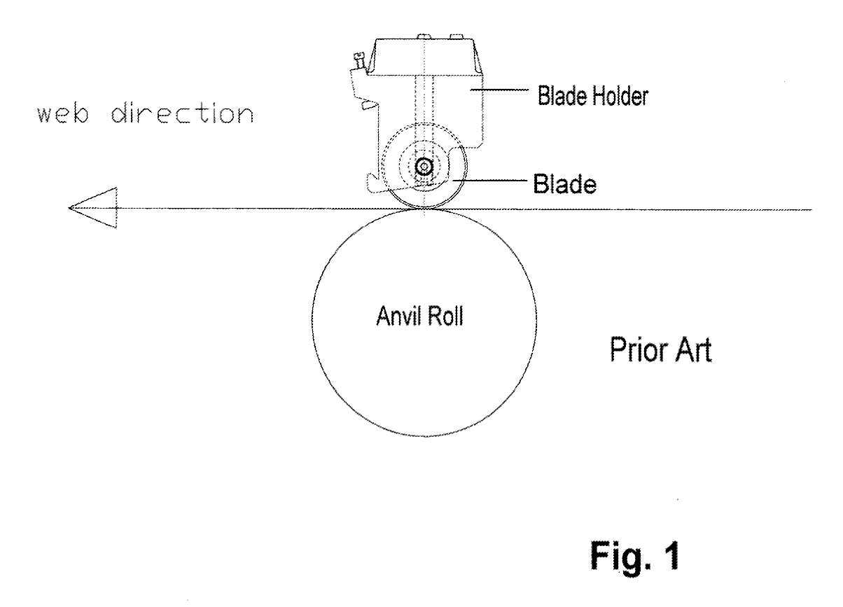

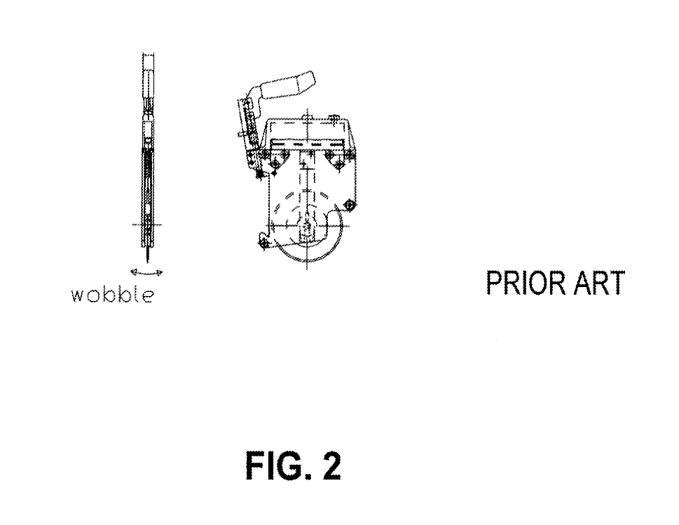

Referring now to the drawings in detail, FIGS. 1 and 2 show a single row radial bearing prior art crush or score cutter. FIG. 2 in particular indicates the wobble, which denotes a misalignment, of the blade of such a prior art device.

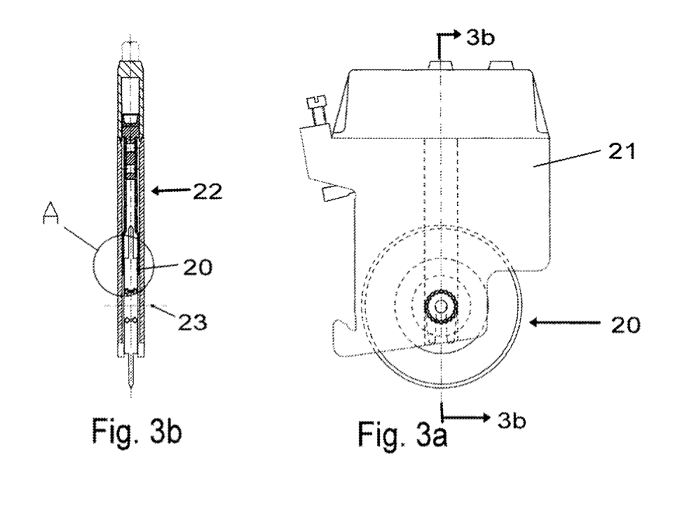

The crush cut blade assembly of the present application, which is designated generally by reference numeral 20, will now be described in conjunction with FIGS. 3 to 8.

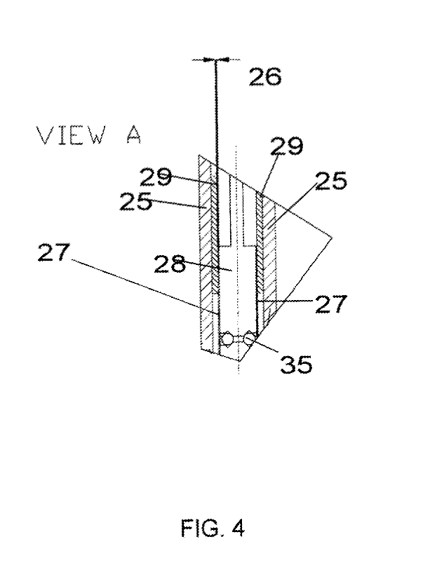

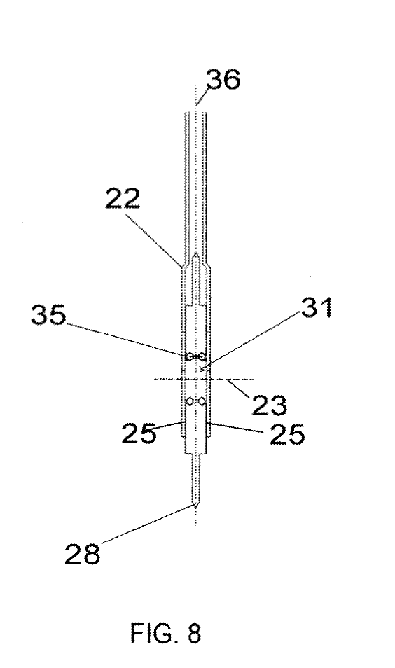

In FIGS. 3a and 3b, the crush cut blade assembly 20, which has an integral bearing support, is shown mounted in a holder 21, in particular, the crush cut blade assembly 20 of the present application is mounted in a fork support 22 of the holder 21 such that the crush cut blade assembly 20 is rotatable about an axis of rotation 23. An enlargement of encircled area A of FIG. 3b is shown in FIG. 4, which shows the crush cut blade assembly 20 mounted between the legs 25 of the fork support 22 (see also FIG. 8). Also shown in FIG. 4 is the clearance 26 between at least a portion of the outer surfaces 27 of the blade or knife 28 of the crush cut blade assembly 20, and the side plates 29 of the legs 25 of the fork support 22, when the crush cut blade assembly 20 is mounted in the fork support 22.

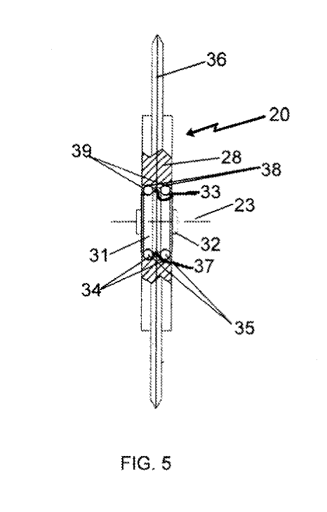

The enlarged view of FIG. 5 shows the dual vee race concept of the crush cut blade assembly 20 of the present application. In particular, the crush cut blade assembly 20 includes an axle pin 31, the hub 32 of which is mounted in the legs 25 of the fork support 22 so as to be coaxial with the axis of rotation 23. The radially outer periphery 33 of the axle pin 31 is provided with a first set of dual vee tracks 34, which form the first, radially inner, race for the bearing balls 35.

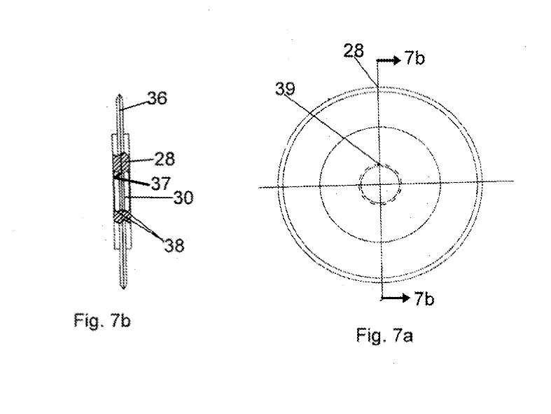

The crush cut blade assembly 20 also includes the blade 28, the central bore 30 of which (see FIG. 7) is formed by a radially inner periphery 37 which, across from the radially outer periphery 33 of the axle pin 31, is provided with a second set of dual vee tracks 38, which form the second, radially outer, race for the bearing balls 35. The blade 28 is disposed radially outwardly of, and concentrically about, the axle pin 31, whereby the vee tracks 38 of the blade 28 are disposed across from the vee tracks 34 of the axle pin 31 such that the vee tracks of the first and second sets of dual vee tracks are respectively aligned with one another. In particular, a respective one of the vee tracks 34 and 38 of each of the first and second sets of dual vee tracks are disposed on each side of the radially extending central plane 36 of the crush cut blade assembly 20, preferably symmetrically relative to the central plane 36. The bearing balls 35 are disposed in the vee tracks 34, 38 of the aligned first and second sets of dual vee tracks; the bearing balls 35 are introduced through slot openings 39 provided on both sides of the crush cut blade assembly 20.

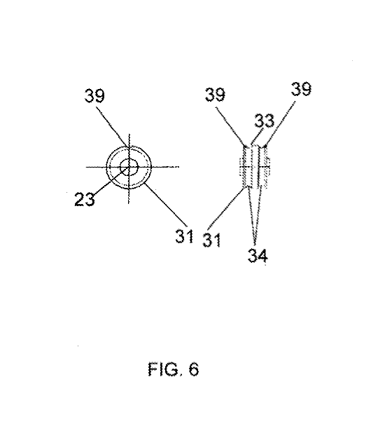

Details of the axle pin 31 and of the blade 28 are shown in FIGS. 6 and 7 respectively. The first set of vee tracks 34 in the radially outer periphery 33 of the axle pin 31 is shown in FIG. 6, which furthermore shows the symmetrical arrangement of the two vee tracks 34. Also shown are the slot openings 39 for the bearing balls 35. Similarly, the second set of vee tracks 38 in the radially inner periphery 37 of the blade 28 is shown particularly clearly in FIG. 7b, with a respective one of the vee tracks 38 being disposed on each side of the central plane 36. In the illustrated embodiment, the two vee tracks 38 are disposed symmetrically relative to the central plane 36. Also shown are the slot openings 39 for the introduction of the bearing balls 35.

The assembled crush cut blade assembly 20 (see also FIG. 5) is once again illustrated in FIG. 8, with the crush cut blade assembly here being shown mounted between the legs 25 of the fork support 22 of the holder 21. As can be seen, the two vee tracks 34, 38 of the first and second sets of vee tracks are respectively aligned with one another on each side of the central plane 36. The two sets of aligned dual vee tracks 34, 38 of the crush cut blade assembly 20 of the present application in the axle pin 31 and the blade 28 overcome the wobble, and resulting misalignment, to which prior known crush or score cutters are susceptible, thus improving the life of the bearings and hence the overall life of the crush cut blade assembly 20.

As also discussed previously, the close tolerances required by the prior art assemblies cause a build-up of heat when the assemblies operate at high speed. The present invention does not require such close tolerances due to the balanced, dual vee track races provided by the first and second sets of vee tracks 34, 38. Therefore, a greater clearance 26, for example of from 0.010 to 0.015 inches, can be provided between the outer surfaces 27 of the blade 28 and the side plates 29 of the legs 25 of the fork support 22, thus greatly reducing the build-up of heat between the outer surfaces 27 of the blade 28 and the side plates 29 of the fork support 22, resulting in an increased service life of the crush cut blade assembly 20 of the present application.

The blade 28 and the axle pin 31 are, as mentioned above, typically made of hardened steel. However, they could also be made of other materials, such as stainless steel. In addition, the blade 28 and the axle pin 31 need not necessarily be made of the same material. By way of example only, the axle pin 31 could be made of D-2 steel, while the blade 28 could be made of CPM-10V steel.

The present invention is, of course, in no way restricted to the specific disclosure of the specification and drawings, but also encompasses any modifications within the scope of the appended claims.

What I claim is:

1. A crush cut blade assembly, comprising:
an axle pin adapted to be mounted in a holder, wherein said axle pin is provided with a first set of two separate vee tracks disposed on a radially outer periphery of said axle pin;
a blade disposed radially outwardly of, and concentrically about, said axle pin, wherein said blade is provided with a second set of two separate vee tracks disposed on a radially inner periphery of said blade, and wherein said vee tracks of said blade are respectively disposed across from said vee tracks of said axle pin such that said vee tracks of said first set of vee tracks are respectively aligned with said vee tracks of said second set of vee tracks; and
bearing balls disposed between said axle pin and said blade in both of said aligned vee tracks of said axle pin and of said blade.

2. A crush cut blade assembly according to claim 1, wherein the vee tracks of the first and second sets of vee tracks are respectively disposed on opposite sides of a radially extending, central plane of said crush cut blade assembly.

3. A crush cut blade assembly according to claim 2, wherein said vee tracks of the first and second sets of vee tracks are disposed symmetrically relative to said central plane of said crush cut blade assembly.

4. A crush cut blade assembly according to claim 2, wherein at least one respective slot opening is provided on opposite sides of said crush cut blade assembly between said axle pin and said blade to permit introduction of said bearing balls into both of said aligned vee tracks.

5. A crush cut blade assembly according to claim 4, wherein said at least one slot opening is provided partially in said axle pin, adjacent to said radially outer periphery thereof, and partially in said blade, adjacent to said radially inner periphery thereof.

6. A crush cut blade assembly according to claim 2, wherein when said axle pin is mounted in a holder, a clearance of from 0.010 to 0.015 inches is provided between at least a portion of outwardly facing surfaces of said blade and holder surfaces that face said blade.

7. A crush cut blade assembly according to claim 1, wherein said blade and said axle pin are made of steel selected from the group consisting of hardened steel, stainless steel, D-2 steel and CPM-10V steel.

8. A crush cut blade assembly according to claim 1, wherein said blade and said axle pin are made of different materials.

9. A crush cut blade assembly according to claim 8, wherein said blade and said axle pin are made of steel selected from the group consisting of hardened steel, stainless steel, D-2 steel and CPM-10V steel.

10. A method, including the steps of:
providing an axle pin having a first set of two separate vee tracks disposed on a radially outer periphery of said axle pin;
providing a blade having a second set of two separate vee tracks disposed on a radially inner periphery of said blade;
disposing said blade radially outwardly of, and concentrically about, said axle pin such that said vee tracks of said blade are respectively disposed across from said vee tracks of said axle pin such that said vee tracks of said first set of vee tracks are respectively aligned with said vee tracks of said second set of vee tracks; and
introducing bearing balls between said axle pin and said blade into both of said aligned vee tracks of said axle pin and of said blade to form a crush cut blade assembly.

11. A method according to claim 7, wherein said vee tracks of said first and second sets of vee tracks are respectively disposed on opposite sides of a radially extending, central plane of said crush cut blade assembly.

12. A method according to claim 8, wherein said vee tracks of the first and second sets of vee tracks are disposed symmetrically relative to said central plane of said crush cut blade assembly.

13. A method according to claim 8, wherein at least one respective slot opening is provided on opposite sides of said crush cut blade assembly between said axle pin and said blade to permit introduction of said bearing balls into both of said aligned vee tracks.

14. A method according to claim 10, wherein said at least one slot opening is provided partially in said axle pin, adjacent to said radially outer periphery thereof, and partially in said blade, adjacent to said radially inner periphery thereof.

15. A method according to claim 8, which includes the further step of mounting said axle pin in a holder such that a clearance of from 0.010 to 0.015 inches is provided between at least a portion of outwardly facing surfaces of said blade and holder surfaces that face said blade.

16. A method according to claim 10, wherein said blade and said axle pin are made of steel selected from the group consisting of hardened steel, stainless steel, D-2 steel and CPM-10V steel.

17. A method according to claim 10, wherein said blade and said axle pin are made of different materials.

18. A method according to claim 17, wherein said blade and said axle pin are made of steel selected from the group consisting of hardened steel, stainless steel, D-2 steel and CPM-10V-steel.
